(19) United States
(12) Patent Application Publication
(10) Pub. No.: US 2010/0139104 A1
(43) Pub. Date: Jun. 10, 2010

(54) COMPASSES WRITING IMPLEMENT

(75) Inventor: Fritz Lüttgens, Erlangen (DE)

Correspondence Address: LERNER GREENBERG STEMER LLP, P O BOX 2480, HOLLYWOOD, FL, 33022-2480, US

(73) Assignee: KUM LIMITED, Trim (IE)

(21) Appl. No.: 12/635,162

(22) Filed: Dec. 10, 2009

(30) Foreign Application Priority Data
Dec. 10, 2008 (DE) DE202008016339.0

(51) Int. Cl. B43L 9/02

(52) U.S. Cl. 33/27.02

(57) ABSTRACT

A compasses writing implement includes a compasses body having two compasses legs mutually pivotable between closed and splayed-out states. A writing lead is mounted in one of the compasses legs. A protective cap is or can be fitted onto the free end of at least the compasses leg holding the writing lead, to shield the free ends of the two compasses legs in the closed state from the outside. The protective cap has a passage for the writing lead at a distal end remote from the compasses body in the fitted state. The writing lead and the fitted protective cap are mutually displaceable between a release state and a retention state. In the release state, a lead tip of the writing lead protrudes through the passage of the protective cap to the outside and in the retention state, the writing lead is retracted in the interior of the protective cap.

### CROSS-REFERENCE TO RELATED APPLICATION

This application claims the priority, under 35 U.S.C. §119, of German Patent Application DE 20 2008 016 339.0, filed Dec. 10, 2009; the prior application is herewith incorporated by reference in its entirety.

### BACKGROUND OF THE INVENTION

### Field of the Invention

The invention relates to a compasses writing implement.

A compasses writing implement is referred to below as an implement that can be used, on one hand, in the manner of a pencil for writing and, on the other hand, can also be used as a pair of compasses for drawing circular lines. A compasses writing implement is known, for example, from German Utility Model DE 71 36 753 U. That writing implement includes a compasses body with a holder on which two compasses legs are pivotably mounted. The compasses legs, as is generally common in the case of pairs of compasses, can be pivoted one relative to the other between a closed state, in which the compasses legs abut against each other in a parallel position, and a splayed-out state, in which the compasses legs form an adjustable angle. A writing lead is mounted on one of the compasses legs. The other compasses leg bears a compasses tip. The known compasses writing implement also includes a protective cap that can be slipped over the two compasses legs in such a manner that it secures the same in the closed state. For writing purposes, the known compasses writing implement includes an additional writing lead which is integrated in the holder of the compasses body and which, in a writing mode, projects at the free end of the holder remote from the compasses legs.

Another compasses writing implement is known from German Published, Non-Prosecuted Patent Application DE 2 234 274 A, corresponding to U.S. Pat. No. 3,797,117. That compasses writing implement also has two compasses legs that are pivotable one relative to the other and one of the compasses legs holds a ballpoint pen cartridge in a fixed manner. That compasses leg basically has an outer contour that corresponds to a conventional ball point pen. Contrary to a conventional ballpoint pen, however, a longitudinal groove is provided in the circumference of the compasses leg, into which longitudinal groove the second compasses leg is pivotable in the closed state.

Yet another compasses writing implement is known from German Published, Non-Prosecuted Patent Application DE 335 280 A. In the case of that compasses writing implement, in order to use the writing implement as a pencil, the compasses legs are not pivoted into the closed state, but into a state in which the compasses legs are aligned with one another in a straight line and, at the same time, in axial extension together form the pencil body.

A pair of compasses with a protective cap that can be fitted onto the free ends of the two compasses legs in order to protect their free ends from damage, is also known from German Utility Model DE 18 47 774 U.

### SUMMARY OF THE INVENTION

It is accordingly an object of the invention to provide an improved compasses writing implement, which overcomes the hereinafore-mentioned disadvantages of the heretofore-known devices of this general type and which, in particular, is especially simple to manage.

With the foregoing and other objects in view there is provided, in accordance with the invention, a compasses writing implement, comprising a compasses body including two compasses legs having free ends and being mounted pivotably relative to one another between a closed state and a splayed-out state, a writing lead held on one of the compasses legs and having a lead tip, and a protective cap fitted or to be fitted onto the free end of at least the compasses leg holding the writing lead for shielding at least the free end from the outside in the closed state. The protective cap has an interior, a distal end remote from the compasses body in a fitted state and a passage in the distal end for the writing lead. The writing lead and the fitted protective cap are displaceable relative to one another between a release state in which the lead tip of the writing lead projects through the passage to the outside, and a retention state in which the writing lead is retracted in the interior of the protective cap.

Accordingly, the compasses writing implement, which is also referred to below in brief, without loss of generality, as a “compasses pencil,” has a compasses body with two compasses legs mounted so as to be pivotable one relative to the other. The compasses legs, in this case, are pivotable between a closed state (abutting against each other) and a state in which they are splayed apart (by an adjustable angle). A writing lead is mounted in this case on one of the compasses legs. The compasses pencil also includes an, in particular tapering, protective cap. The protective cap can be fitted (in the removed state) or is fitted (in the fitted state) onto the free end of that compasses leg which holds the writing lead, in such a way that in the fitted state, the protective cap protects the free ends of the compasses legs that abut together in the closed position from the outside.

According to the invention, the protective cap is provided at a distal end with a passage for the writing lead. A distal end of the protective cap refers in this case to that end which in the fitted state is remote from the compasses body. In addition, the writing lead and the protective cap fitted onto the compasses body are displaceable one relative to the other in such a manner that, in a release state, a lead tip of the writing lead projects through the passage of the fitted protective cap to the outside, and that, in a retention state, the writing lead is retracted in the interior of the protective cap. The writing lead is preferably a ballpoint pen cartridge or a lead produced from an abrasive material (writing lead, crayon lead or similar). In principle, however, any other arbitrary types of lead or cartridge, in particular felt or fiber, can be used.

When not being used, that is in particular for transport and for storage, the compasses pencil is used normally with the protective cap fitted, in which state the writing lead is concealed in the retention state within the protective cap, and consequently damage to the writing lead or inadvertent contamination of the environment by the writing lead is ruled out. For the compasses mode, the compasses pencil is used normally with the protective cap removed in such a way that the free ends of both compasses legs are accessible from outside and consequently the compasses writing implement can be used in the manner of an ordinary pair of compasses. The same writing lead is used normally for the writing mode as for the compasses mode. In this case, the writing implement is used normally but once again with the protective cap fitted, with the writing lead for this purpose being displaced into the release state, that is to say pushed through the passage in the protective cap.

Due to the relative displaceability of the protective cap and of the writing lead, the compasses pencil with the protective cap fitted can be operated with the same ease and precision as a conventional ballpoint pen or mechanical pencil. At the same time, it is particularly easy to convert the compasses pencil from the writing function to the compasses function simply by removing the protective cap. Using the same writing lead both for the writing mode and for the compasses mode achieves particularly simple manageability, in particular also because the compasses pencil does not have to be turned the other way up for these two types of use. At the same time, this also simplifies the manufacturing of the compasses pencil and makes for a particularly compact construction of the compasses pencil.

It is important for the above-described functioning of the compasses pencil, in particular, that the writing lead is mounted, even with the protective cap removed, on the associated compasses leg, i.e. secured in a fixed or at least radially fixed manner in such a way that the compasses pencil can be used even when the protective cap has been removed. In other words, if need be, an additional support and guiding function for the writing mode is provided by the protective cap.

In accordance with another feature of the compasses pencil of the invention, in the fitted state, the protective cap, at least in the axial direction of the compasses body, is mounted, in particular locked, in a fixed manner on the compasses body. In order to adjust the compasses pencil between the release state and the retention state, in this case, the writing lead, also and even with the protective cap placed on, is guided so as to be displaceable in the associated compasses leg. In order to displace the writing lead, a feed mechanism for the writing lead is integrated for this purpose in an expedient manner in the associated compasses leg. In so far as the writing lead is a ballpoint pen cartridge, the feed mechanism is realized in an expedient manner in the manner of a conventional ballpoint pen mechanism. This can be realized in the manner of the “push-push mechanism” widely used in the case of ballpoint pens, where the writing lead is locked in an advanced position simply by actuating an actuating member, and is unlocked by actuating the same again in the same direction. For reasons of greater simplicity, for advancing a ballpoint pen cartridge a “push-rest mechanism” is also used as an alternative to this, where the ballpoint cartridge is displaced into the advanced position through the use of a slider and is locked in this position, and wherein for resetting the ballpoint pen cartridge, the locking is released at a separate location. In so far as the writing lead, as an alternative to this, is formed by a pencil or crayon lead, the feed mechanism is realized expediently in the manner of the feeding mechanism of a mechanical pencil or fine tip pen. In all cases the feed mechanism is expediently provided with an actuating member that protrudes to the outside on the circumference of the associated compasses leg, i.e. on a radial outer wall of the same.

In accordance with a further feature of the compasses pencil of the invention, the protective cap is lockable in the fitted state between two axial longitudinal displacement positions on the compasses body. The longitudinal displacement positions correspond to the release state or the retention state. In this embodiment, the writing lead is expediently, but not necessarily, held in a fixed manner on the associated compasses leg.

In accordance with an added feature of the compasses pencil of the invention, the protective cap can be fitted or is fitted onto the free ends of the two compasses legs in such a manner that the compasses legs are secured by the protective cap in their closed state. The compasses legs are consequently secured against inadvertently splaying out through the use of the protective cap, in particular for the purposes of storage and transport.

In accordance with an additional, alternative feature of the compasses pencil of the invention, the protective cap can simply be fitted directly onto that compasses leg which bears the writing lead. On the side facing the other compasses leg, the protective cap in this case is provided with a longitudinal groove or a notch, through which that compasses leg can be passed. In this embodiment, the free end of the additional compasses leg in the closed state is also within the protective cap and is consequently reliably protected against contact from the outside. At the same time, however, it is possible to splay the compasses legs apart without removing the protective cap.

In accordance with yet another feature of the compasses pencil of the invention, for particularly good manageability of the compasses pencil in writing mode, it is advantageously provided that the writing lead is located in such a manner in the associated compasses leg that in the closed state of the compasses legs, it is oriented substantially coaxially to the (longitudinal) axis of the compasses body, and consequently substantially centrally to the same.

In accordance with yet an added feature of the compasses pencil of the invention, for simplified handling of the compasses pencil in compasses mode, it is preferably provided additionally or alternatively hereto that the compasses legs are coupled together in such a manner that the two compasses legs are only able to be splayed out in each case in a symmetrical manner by identical angles from the (longitudinal) axis of the compasses body. Such a coupling mechanism is known per se, for example, from German Utility Model DE 71 36 753 U.

In accordance with yet an additional feature of the compasses pencil of the invention, once again for improved manageability of the compasses pencil in writing mode, the compasses legs are shaped in an expedient embodiment in such a manner that they, together with the fitted protective cap, form an ergonomically rounded outer contour, substantially in the manner of an elongated oval or in the manner of a spheroid. In addition to or as an alternative thereto, the protective cap can be provided with ergonomically shaped recessed grips for the fingers of a hand holding the compasses pencil.

In accordance with a concomitant feature of the compasses pencil of the invention, a securing clip that points to the compasses body is mounted, in particular integrally formed, on the protective cap. Through the use of the securing clip, the compasses pencil can be secured in a pocket, for example on the clothes of a user or in a briefcase. As an alternative, such a bracket can also be mounted, in particular integrally formed, on one of the compasses legs or on a holder holding the same, and then preferably points to the free end of the compasses legs.

Other features which are considered as characteristic for the invention are set forth in the appended claims.

Although the invention is illustrated and described herein as embodied in a compasses writing implement, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, side-elevational view of a first embodiment of a compasses pencil with a compasses body including a holder and two compasses legs, and with a protective cap fitted onto the compasses legs in their closed position, with a writing lead held in one of the compasses legs being concealed in a retention state within the protective cap;

FIG. 2 is a side-elevational view of the compasses pencil in the state shown in FIG. 1, rotated by 90°;

FIG. 3 is a partially broken-away and longitudinal-sectional view of the compasses pencil in the orientation shown in FIG. 2;

FIG. 4 is a view similar to FIG. 1 of the compasses pencil shown in FIG. 1, with the writing lead being displaced into a release state in which it protrudes out of the fitted protective cap;

FIG. 5 is a view of the compasses pencil in the state shown in FIG. 4, but in the representation shown in FIG. 2;

FIG. 6 is a view of the compasses pencil in the state shown in FIG. 4, but in the representation shown in FIG. 3;

FIG. 7 is a cross-sectional view of the compasses pencil shown in FIG. 1, which is taken along the line VII-VII in FIGS. 2, 3, 5 and 6, in the direction of the arrows;

FIG. 8 is a view of the compasses pencil shown in FIG. 1 in the representation and state shown in FIG. 2, but with the protective cap removed;

FIG. 9 is a view of the compasses pencil in the state shown in FIG. 8, but in the representation shown in FIG. 3;

FIG. 10 is a view of the compasses pencil in the representation shown in FIG. 1 in the state shown in FIG. 8, but with the compasses legs splayed apart;

FIG. 11 is a view of the compasses pencil shown in FIG. 1 in the state shown in FIG. 10, but in the representation shown in FIG. 3;

FIG. 12 is a partially broken-away and longitudinal-sectional view of a second embodiment of the compasses pencil in the representation shown in FIG. 3, where the writing lead is secured in a fixed manner in the associated compasses leg, and where the protective cap in the fitted state is lockable in two longitudinal displacement positions with reference to the compasses body, represented in the retention state in which the writing lead is concealed within the protective cap;

FIG. 13 is a view of the compasses pencil shown in FIG. 12 in the representation given there, but in the release state in which the writing lead protrudes out of the protective cap;

FIG. 14 is a fragmentary, side-elevational view as in FIG. 1 of a portion of the compasses body of the compasses pencil shown in FIGS. 12 and 13 with the protective cap removed;

FIG. 15 is a partially broken-away and longitudinal-sectional view of another embodiment of the compasses pencil in the representation shown in FIG. 3, where the compasses legs can be splayed apart with the protective cap fitted;

FIG. 16 is a view of the compasses pencil shown in FIG. 15 in the representation shown in FIG. 11 with the compasses legs splayed apart; and

FIGS. 17 to 22 are views of two further embodiments of the compasses pencil as shown respectively in FIG. 2, FIG. 3 and FIG. 11, where the compasses legs in the closed position together with the fitted protective cap form a rounded outer contour.

### DETAILED DESCRIPTION OF THE INVENTION

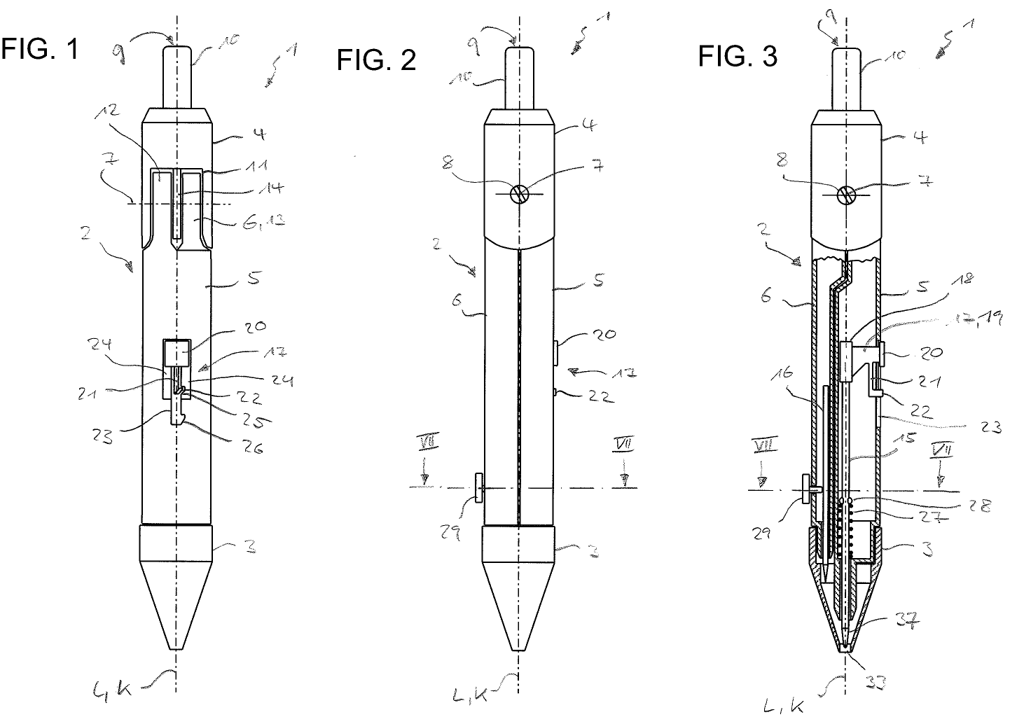

Referring now in detail to the figures of the drawings, in which identical reference numerals are always provided in all of the figures for parts that correspond to one another, and first, particularly, to FIG. 1 thereof, there is seen a compasses pencil 1 which is represented in a first embodiment initially in FIGS. 1 to 11 and includes an elongate compasses body 2 and a protective cap 3. The compasses body 2, in turn, includes a holder 4 and two compasses legs 5 and 6, which are mounted on the holder 4 so as to be pivotable about an axis 7. The compasses legs 5 and 6, in this case, are pivotally mounted on the holder 4 through the use of a securing screw 8 that is guided coaxially relative to the axis 7.

The holder 4 is produced, in particular, as an injection molded part or die cast part made from plastics material, aluminum or magnesium and is drawn out at its free end 9 remote from the compasses legs 5 and 6 to form a pencil-shaped grip projection 10. Opposite the free end 9, the holder 4 is provided with a receiving device 11 which, when seen in a top view as in FIG. 1, is approximately U-shaped with walls which are oriented transversely to the axis 7, and in which the compasses legs 5 are inserted in each case by way of a pivot joint projection 12, 13. A partition 14, which is guided on the holder 4 so as to be longitudinally displaceable but non-rotatable, is located between the pivot joint projections 12 and 13. By engaging the pivot joint projections 12 and 13 in corresponding guide ways of the partition 14, the compasses legs 5 and 6 are coupled together in such a manner that they are always only capable of being pivoted out in a symmetrical manner by identical angles with reference to a longitudinal axis L of the compasses body 2. The principle of a corresponding coupling mechanism is disclosed, for example, in German Utility Model DE 71 36 753 U.

The compasses legs 5 and 6, in turn, are preferably formed as hollow shaped parts made from plastics material, aluminum or magnesium. The compasses leg 5, in this case, is for holding a writing lead 15, which in the example represented is a conventional ballpoint pen cartridge. The compasses leg 6 is used for holding a compasses tip 16 made of steel.

Both the writing lead 15 and the compasses tip 16 are guided so as to be displaceable in the respective compasses leg 5 and 6 and can be secured through the use of a corresponding fixing device in various longitudinal displacement positions with reference to the respective compasses leg 5 or 6. In the case of the writing lead 15, the fixing device is formed by a ballpoint pen mechanism 17 constructed in the manner of a “push-rest mechanism.” The ballpoint pen mechanism 17 includes a sleeve 18 provided with a blind bore hole and fitted onto a rear end of the writing lead 15. The sleeve 18 is connected through the use of an integrally molded connecting web 19 to a slider 20 that protrudes partially on the outer circumference of the compasses leg 5. A spring arm 21, which has a locking hook 22 at its free end, is also mounted, in particular integrally formed in one piece, on the connecting web 19.

The connecting web 19 is guided so as to be displaceable along the longitudinal axis L in an elongate hole 23 that is formed into the wall of the compasses leg 5. Indentations 24 are provided in the outer wall of the compasses leg 5 over a partial region of the length of the elongate hole 23 on both sides of the same. The indentations act as a bed for the slider 20.

Two recesses 25 and 26 are provided in the elongated hole 23 at the side of the same. The locking hook 22 locks into the recesses in various displacement positions of the slider 20.

A compressed spiral spring 27 is also a component part of the ballpoint pen mechanism 17 and pretensions the writing lead 15 in the direction of the sleeve 18. The compressed spiral spring 27 surrounds the writing lead 15 and is supported between the compasses leg 5 and two radial embossings 28 of the writing lead 15.

The compasses tip 16 is securable so as to be reversible on the compasses leg 6 through the use of a securing screw 29. The securing screw 29, in this case, mates with an associated threaded bore that is provided in the wall of the compasses leg 6.

The protective cap 3 is realized as a shaped part, in particular as an injection molded component made of plastics material. It is substantially in the form of a tapered sleeve. The protective cap 3 is provided with a comparably wide top opening 30 (FIG. 9) at one of its axial ends. At the oppositely situated axial end (hereafter referred to as distal end 32), the protective cap 3 has a narrow passage 33 that is located concentrically to a cap axis K.

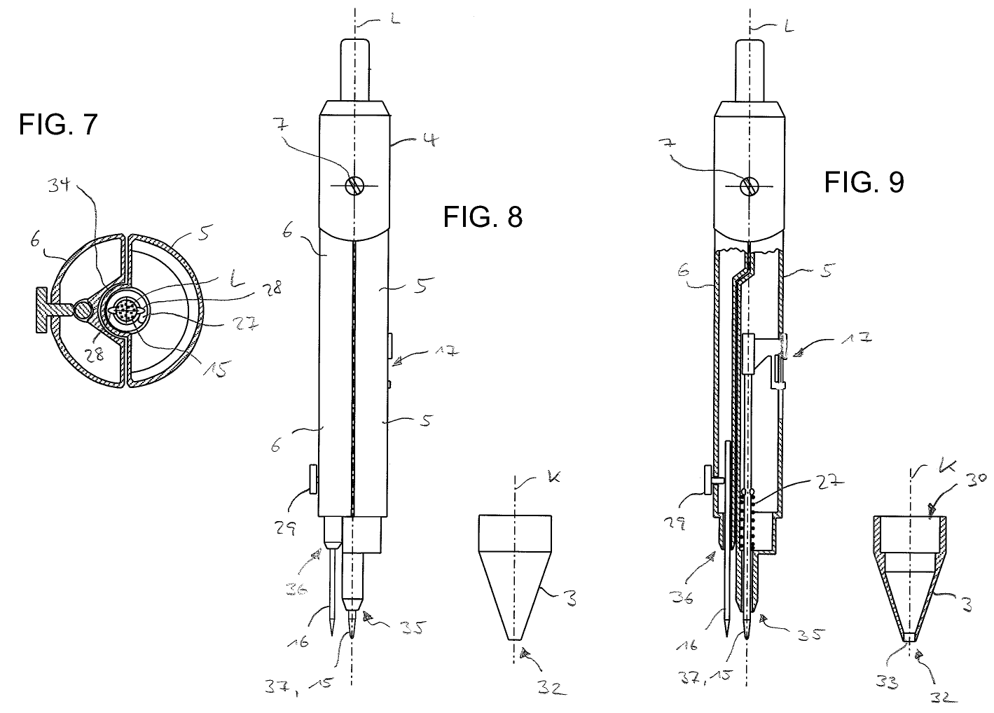

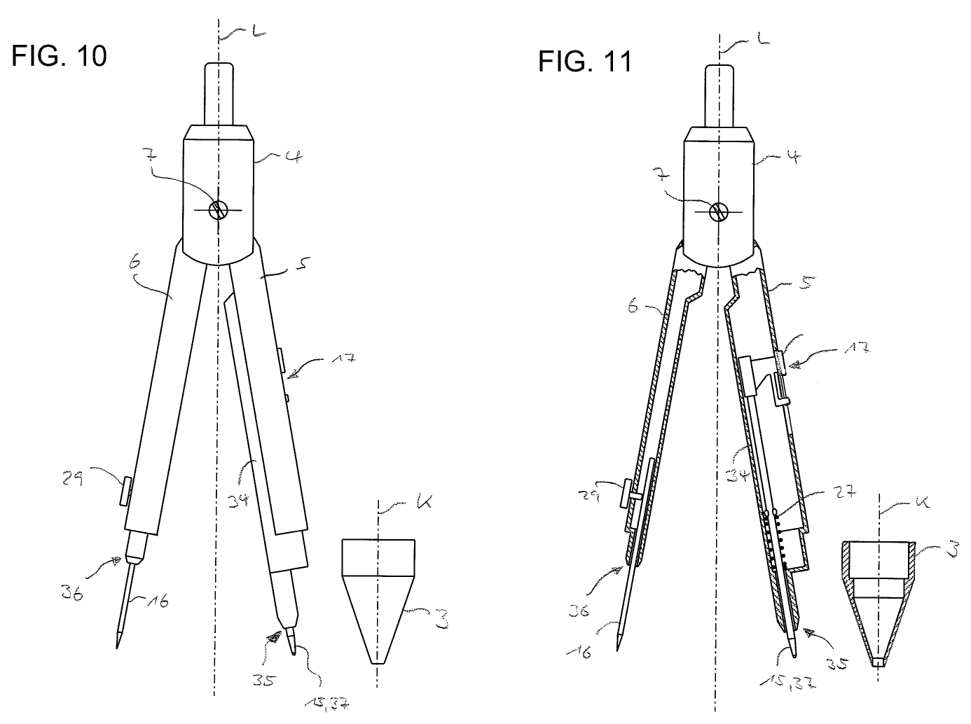

FIGS. 1 to 9 show the compasses legs 5 and 6 of the compasses pencil 1 in a closed state, in which the compasses legs 5 and 6 abut against each other parallel to the longitudinal axis L. The compasses legs 5 and 6 together with the holder 4, in this case, form a substantially pencil-shaped, preferably approximately circular cylindrical outer contour (see FIG. 7). As is clear from FIGS. 3, 6 and 7 in particular, in this case, the compasses leg 6 is provided on its inner wall with an approximately semi-cylindrical recess, into which the compasses leg 5 extends by way of a substantially complementarily formed projection 34 (see FIGS. 10 and 11). The writing lead 15 lies in the projection 34 in the interior of the compasses leg 5 in such a manner that the writing lead 15, in the closed position of the compasses legs 5 and 6, is oriented co-linearly with the longitudinal axis L. This means that the writing lead 15 is located, in particular, centrally with reference to the outer contour formed by the closed compasses legs 5 and 6.

The protective cap 3 is fitted onto free ends 35 and 36 (FIGS. 8 and 9) of the compasses legs 5 or 6 in such a manner that, in the fitted state, it protects the free ends 35 and 36 from the outside. In this case, in the fitted state, the protective cap 3 also secures the compasses legs 5 and 6 in their closed position and consequently prevents the compasses legs 5 and 6 from inadvertently splaying open.

The compasses tip 16 is concealed in the interior of the protective cap 3 with the protective cap 3 fitted in place. To this end, the compasses tip 16 is inserted into the compasses leg 6 in such a manner that it only extends out of the compasses leg in a negligible manner.

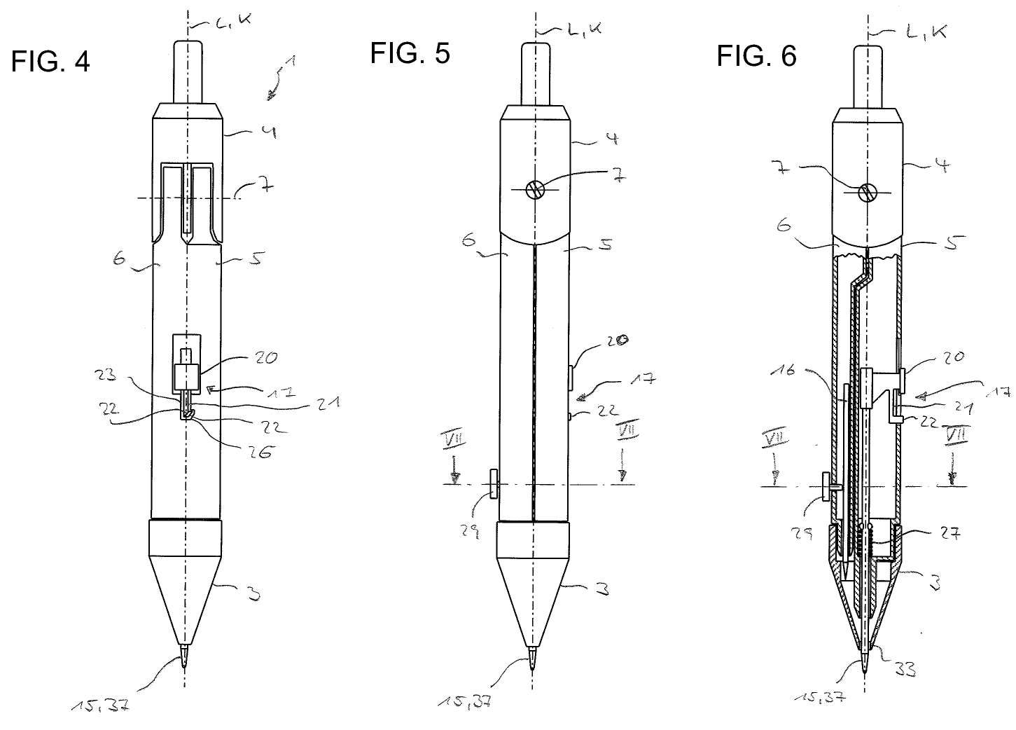

The protective cap 3 is fitted onto the free ends 35 and 36 of the compasses legs 5 and 6 in such a manner that its cap axis K is aligned with the longitudinal axis L of the compasses body 3. In the fitted state, the protective cap 3, in this case, is located in such a manner with reference to the compasses leg 5 and to the writing lead 15 held in the compasses leg, that by actuating the ballpoint pen mechanism 17, the writing lead 15 can be displaced between a release state, in which the writing lead 15 extends through the passage 33 of the protective cap 3 to the outside by way of a lead tip 37, and a retention state, in which the writing lead 15 is totally concealed in the fitted protective cap 3. FIGS. 1 to 3 show the compasses pencil 1 in the retention state of the writing lead 15, with the compasses legs 5 and 6 in the closed position and the protective cap 3 fitted. FIGS. 4 to 6 show the compasses pencil 1 in the release state of the writing lead 15, likewise with the compasses legs 5 and 6 in the closed position and the protective cap 3 fitted.

The compasses pencil 1 is held in the retention state as in FIGS. 1 to 3, in particular for the purposes of storage and transport, that is to say whenever the compasses pencil 1 is not being used. In contrast, the compasses pencil 1 is then moved into the release state when the compasses pencil 1 is to be used for writing in the manner of a conventional ballpoint pen. In order to move the writing lead 15 into the release state, the slider 20 is displaced out of the position represented in FIGS. 1 to 3 in the direction of the protective cap 3, until the locking hook 22 locks in the recess 26 of the elongated hole 23 (FIGS. 4 to 6). In order to reset the writing lead 15 into the retention state, the locking hook 22 is manually pivoted out in a tangential manner by resiliently deforming the spring arm 21 until it unlocks from the recess 26. The writing lead 15 is then reset into the retention state, as in FIGS. 1 to 3, through the use of the compressed spiral spring 27.

In order to use the compasses pencil 1 in compasses mode, proceeding from the retention state in FIGS. 1 to 3, the protective cap 3 is removed from the compasses legs 5 and 6 in such a way that the free ends 35 and 36 and the ends of the writing lead 15 or of the compasses tip 16 extending therefrom are accessible from the outside (FIG. 8 and FIG. 9). In order, in compasses mode, to be able to orientate the compasses pencil 1 in an approximately upright manner with reference to the alignment of its longitudinal axis L, by temporarily releasing the securing screw 29, the compasses tip 16 can be advanced until it ends by way of the lead tip 37 approximately at the identical axial height. For compasses mode, i.e. for drawing a circular line, the compasses legs 5 and 6, as with a normal pair of compasses, are pivoted apart until a distance corresponding to the radius of the circle to be drawn is achieved between the end of the compasses tip 16 and the lead tip 37. An example of the compasses legs 5 and 6 in the splayed-out state is represented in FIGS. 10 and 11.

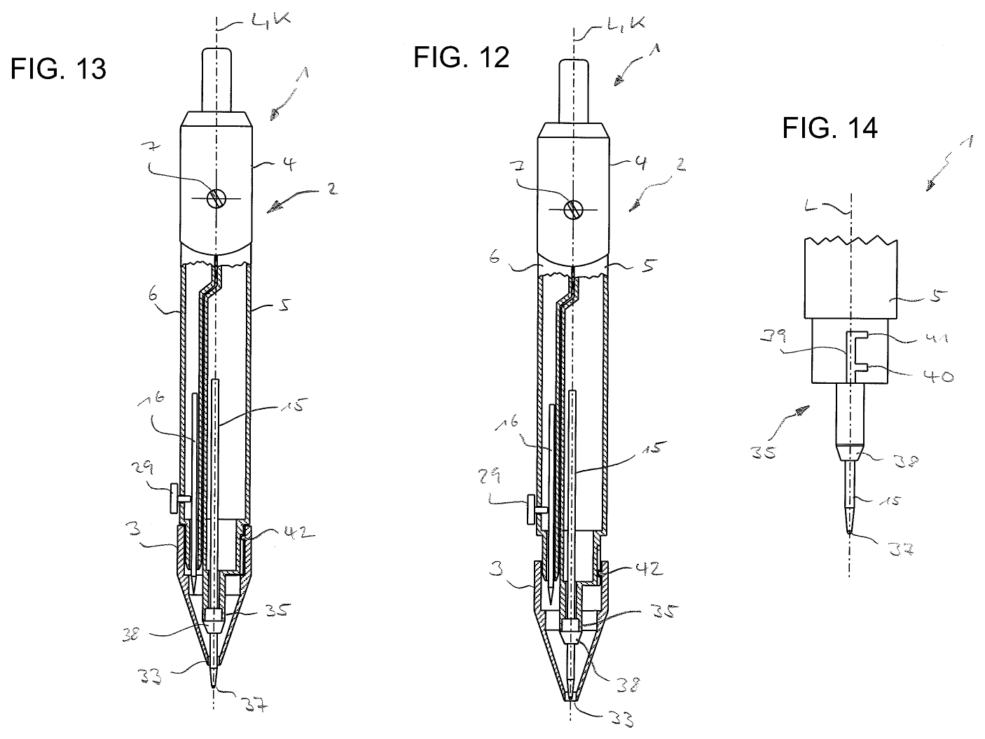

A second embodiment of the compasses pencil 1 is shown in FIGS. 12 to 14. This embodiment is similar to the first embodiment, in so far as nothing to the contrary is described below. The difference in this embodiment, however, is that in FIGS. 12 to 14 the writing lead 15 is held in a fixed manner, that is to say is not displaceable, in the compasses leg 5. To this end an annular projection 38 is mounted in a fixed manner on the writing lead 15 and is inserted by way of a stepped contour in a complementarily formed contour at the free end 35 of the compasses leg 5.

In order to be able to adjust the compasses pencil 1 between the release state and the retention state in spite of the fixed mounting of the writing lead 15, in the embodiment of FIGS. 12 to 14 the protective cap 3, in the fitted state, is lockable to the compasses body 2 in two longitudinal displacement positions with reference to the compasses body. One displacement position of the protective cap 3 corresponding to the retention state, in which the protective cap is only partially fitted onto the compasses legs 5 and 6, is represented in this case in FIG. 12. A further displacement position that corresponds to the release state, in which the protective cap 3 is completely fitted onto the compasses legs 5 and 6, is represented in FIG. 13.

The dual locking capability of the protective cap 3 on the compasses body 2 is achieved through the use of a modified bayonet closure. To this end, an axial guide groove 39 with two tangential protrusions 40 and 41 that are spaced apart is provided at the free end 35 of the compasses leg 5. A guide projection 42 protruding radially inward is integrally formed in the interior of the protective cap 3. The guide projection runs in the guide groove 39 when the protective cap 3 is fitted. In order to lock the protective cap 3 in the longitudinal displacement position corresponding to the retention state (FIG. 12), the guide projection 42, in this case, is pivoted into the protrusion 40. In order to lock the protective cap 3 in the longitudinal displacement position corresponding to the release state (FIG. 13), the guide projection 42 is pivoted into the protrusion 41.

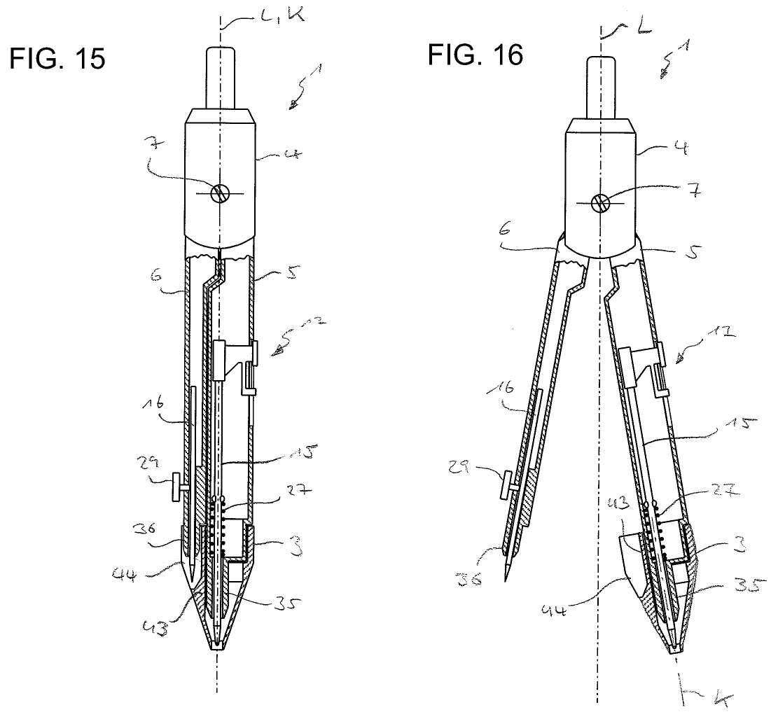

A third embodiment of the compasses pencil 1 is shown in FIGS. 15 and 16. This third embodiment is also similar to the first embodiment, barring the differences named below. Thus, in this case, unlike the protective cap 3 of the previously described embodiments, the protective cap 3 has an intermediate wall 43 that, in the fitted state of the protective cap 3, engages between the free end 35 and the free end 36 of the compasses legs 5 and 6. The protective cap 3, in this case, is strictly fitted just onto compasses leg 5 and therefore, in the fitted state, assumes a force-locking or form-locking connection just with the compasses leg 5 holding the protective cap 3 on the compasses body 2. A force-locking connection is one which connects two elements together by force external to the elements, as opposed to a form-locking connection which is provided by the shapes of the elements themselves. Contrary to this, the compasses leg 6 is not mechanically coupled to the fitted protective cap 3, but rather the free end 36 of the compasses leg 6 in the closed state is loosely enclosed in the interior of the protective cap 3, in such a way that the free end 36 and the compasses tip 16 protruding beyond the free end are protected against contact. On the side facing the compasses leg 6, the protective cap 3 is provided with a lateral opening 44, through which the compasses leg 6 is pivotable between the closed state and the splayed state without the protective cap 3 having had to be removed for this purpose.

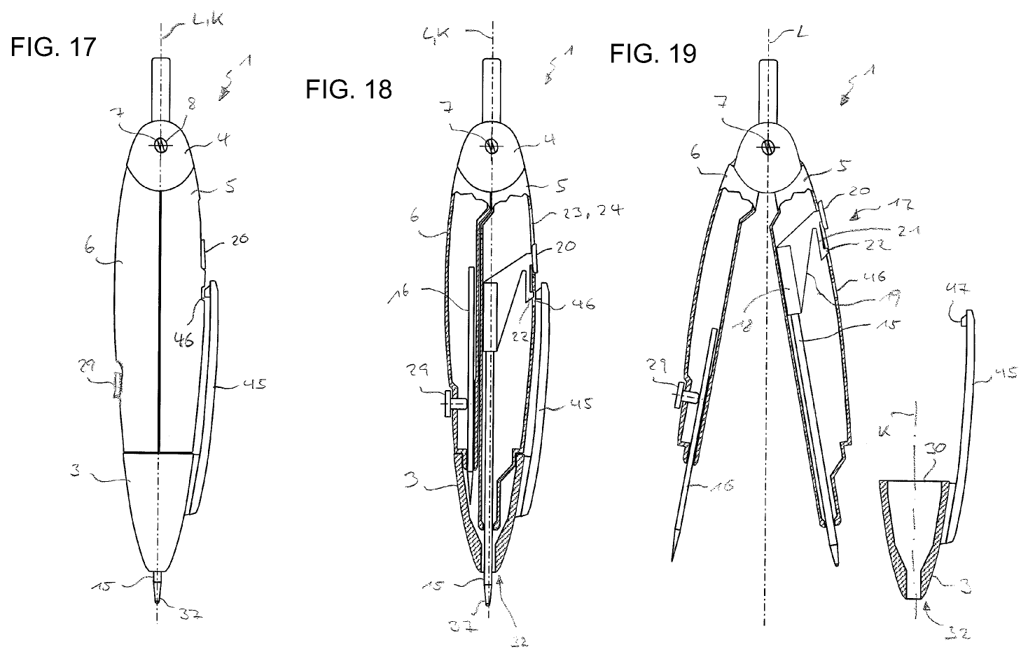

A fourth embodiment of the compasses pencil 1 is represented by way of FIGS. 17 to 19. This embodiment of the compasses pencil 1 also corresponds substantially to the first embodiment. Unlike that embodiment, however, the compasses legs 5 and 6 together with the protective cap 3 form an ergonomically rounded outer contour that corresponds, for instance, to an elongated oval. Unlike the first embodiment, a securing clip 45 is also integrally formed on the protective cap 3, as is usual generally, for example, in the case of ballpoint pens in order to secure them in a jacket pocket or the like. The securing clip 45 protrudes in the direction of the cap axis K beyond the top opening 30 and, in the fitted state of the protective cap 3, runs closely along the outer contour formed by the closed compasses legs 5 and 6.

The cross section of the top opening 30 is developed, in particular, in a noncircular manner in such a way that the protective cap 3 can only be fitted onto the compasses legs 5 and 6 in a specific rotational position. That rotational position is selected, in particular, in such a manner that the securing clip 45 flanks the compasses leg 5 in an approximately central manner.

In the case of the embodiment of FIGS. 17 to 19, in addition it is not possible, for unlocking purposes, to pivot the locking hook 22 of the ballpoint pen mechanism 17 out in a tangential manner but rather in a radial manner. The locking hook 22, in this case, interacts with an opening 46 in the wall of the compasses leg 5 to lock the ballpoint pen mechanism 17. The securing clip 45, in this case, is dimensioned in such a manner that, with the protective cap 3 fitted, an inwardly protruding holding projection 47 located at the free end of the securing clip comes to rest precisely above the opening 46. The holding projection 47 is additionally dimensioned in such a manner that, with pressure exerted radially inwards onto the securing clip 45 of the fitted protective cap 3, the holding projection 47 engages in the opening 46 and unlocks the locking hook 22 possibly held in this case. This means, therefore, that the securing clip 45 can be used to reset the ballpoint pen mechanism 17 in a simplified manner.

A return spring, which is not shown in FIGS. 18 and 19 for reasons of simplification, is also provided in this embodiment for resetting the writing lead 15.

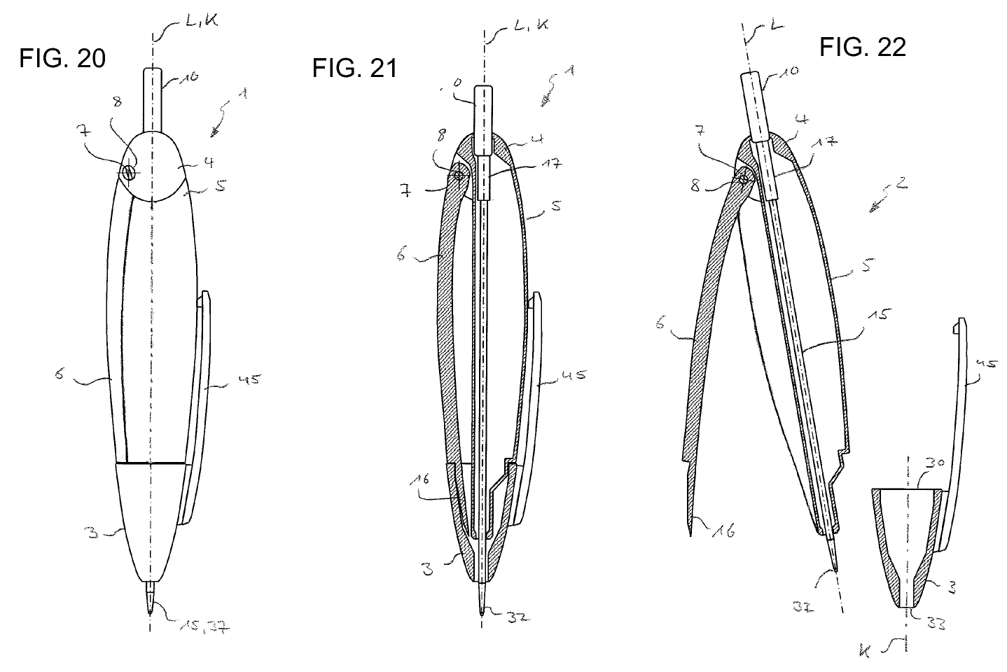

A further embodiment of the compasses pencil 1 is represented in FIGS. 20 to 22. This embodiment corresponds substantially to the last described embodiment. Unlike that embodiment, however, the compasses tip 16 in FIGS. 20 to 22 is located in a fixed manner, in particular is integrated in one piece on the compasses body 6. The ballpoint pen mechanism 17 (only roughly illustrated), in this case, is developed in the manner of a conventional push-push mechanism. The grip projection 10 that, in this case, is correspondingly guided in a longitudinally displaceable manner in the holder 4, serves as an actuating member of the ballpoint pen mechanism 17. In order to enable simple coupling between the ballpoint pen mechanism 17 and the writing lead 15, in this case, the holder 4 is connected in one piece, and consequently in a rigid manner, to the compasses leg 5. The compasses leg 6 is pivotally mounted in an eccentric manner with reference to the longitudinal axis L through the use of the securing screw 8 on that unit, which is formed by the holder 4 and the compasses leg 5.

The return spring has also been omitted in FIGS. 20 to 22 purely for reasons of simplification.

The securing screw 8, in this case, is preferably provided on its head with a grip contour, for example in the form of a protruding web or the like, in such a way that it can be tightened and loosened manually in a reversible manner in order to secure the compasses leg 6 in a predetermined angular position with reference to the compasses leg 5 or in order to enable simple pivoting of the compasses legs. A rubber sleeve or a serrated or resilient washer is preferably positioned underneath the securing screw 8 in order to improve the reciprocal securement of the compasses legs 5 and 6 once the securing screw has been tightened.

In the case of all of the embodiments of the compasses pencil 1 described above, the writing lead 15 can also be securable, similar to the compasses tip 16 in the case of the embodiments of FIGS. 1 to 19, in different longitudinal displacement positions with reference to the compasses leg 5, through the use of a simple clamping mechanism. In the case of all of the embodiments of the compasses pencil 1, the writing lead 15 can also be replaced by a pencil or crayon lead or a felt or fiber pen cartridge. In the first case, the ballpoint pen mechanism 17 is expediently replaced by a feed mechanism for the pencil or crayon lead that is normal for a mechanical pencil or fine tip pencil.

1. A compasses writing implement, comprising:
a compasses body including two compasses legs having free ends and being mounted pivotably relative to one another between a closed state and a splayed-out state;
a writing lead held on one of said compasses legs and having a lead tip; and
a protective cap fitted or to be fitted onto said free end of at least said compasses leg holding said writing lead for shielding at least said free end from the outside in said closed state;
said protective cap having an interior, a distal end remote from said compasses body in a fitted state and a passage in said distal end for said writing lead; and
said writing lead and said fitted protective cap being displaceable relative to one another between:
a release state in which said lead tip of said writing lead projects through said passage to the outside, and
a retention state in which said writing lead is retracted in said interior of said protective cap.

2. The compasses writing implement according to claim 1, wherein said protective cap is fixedly held on said compasses body in said fitted state, and said writing lead is displaceable in said compasses leg holding said writing lead when said protective cap is fitted.

3. The compasses writing implement according to claim 2, which further comprises a feed mechanism for said writing lead being integrated in said compasses leg holding said writing lead.

4. The compasses writing implement according to claim 1, wherein said protective cap is configured to be locked to said compasses body, in said fitted state, in two longitudinal displacement positions corresponding to said release state and said retention state.

5. The compasses writing implement according to claim 1, wherein said protective cap is fitted or is to be fitted onto said free ends of both of said compasses legs for securing said compasses legs in said closed state with said protective cap.

6. The compasses writing implement according to claim 1, wherein said compasses legs are configured to be splayed apart out of said closed position, with said protective cap fitted.

7. The compasses writing implement according to claim 1, wherein said writing lead is a ballpoint pen cartridge or is produced from an abrasive material.

8. The compasses writing implement according to claim 1, wherein said compasses body has a longitudinal axis, and said writing lead is oriented approximately coaxially to said longitudinal axis of said compasses body in said closed state of said compasses legs.

9. The compasses writing implement according to claim 1, wherein said compasses body has a longitudinal axis, and said compasses legs are coupled to only permit them to be splayed out in a symmetrical manner by identical angles relative to said longitudinal axis of said compasses body.

10. The compasses writing implement according to claim 1, wherein said protective cap tapers towards said distal end.

11. The compasses writing implement according to claim 1, wherein said compasses legs, in said closed state, together with said fitted protective cap, form an outer contour being rounded off approximately in an elongated oval or spheroid shape.

12. The compasses writing implement according to claim 1, which further comprises a securing clip located on said protective cap and pointing to said compasses body.
